(19) United States
(12) Patent Application Publication
(10) Pub. No.: US 2002/0144772 A1
(43) Pub. Date: Oct. 10, 2002

(54) Binding agent composition for keypad and method for binding keypad

(76) Inventors: Ming-Rong Wu, Taipei (TW); Chui-Yu Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/953,871

(22) Filed: Sep. 18, 2001

Related U.S. Application Data
(62) Division of application No. 09/499,375, filed on Feb. 7, 2000.

(51) Int. Cl. B32B 31/00

(52) U.S. Cl. 156/275.5

(57) ABSTRACT

A binding agent composition for keypad and method for binding keypad to membrane is disclosed. The binding agent composition for keypad according to the present invention comprises a UV-curable ink and a surfactant and optionally silicone oil, ethyl alcohol, or hexane. The keypad is mounted on the membrane applied with the binding agent composition and cured together such that the keypad is firmly bound to the membrane. The problems of dust invade and incorrect key pressing are overcome.

### FIELD OF THE INVENTION

The present invention relates to a binding agent composition for keypad and method for binding keypad, wherein the keypad can be firmly bound to the membrane applied with the inventive binding agent composition after curing.

### BACKGROUND OF THE INVENTION

The convention method for curing and binding keypad on a membrane includes the steps of applying a binding agent on the membrane, granulating the bottom surface of the keypad, UV-curing the binding agent and granulated surface of the keypad such that the keypad is bound on the membrane. The keypad is generally made of Si rubber and the membrane is generally made of PET.

The adhesion between the keypad and the membrane is generally influenced by the granulating treatment of the keypad, ingredient and formulation of binding agent, intensity and of curing light, running speed, separation of the cured article.

Moreover, the position of the keypad may be drifted during the operation of the keyboard. Therefore, the key stroke signal is influenced and dust is liable to invade into keyboard.

It is the object of the invention to provide a binding agent composition for keypad and method for binding keypad on membrane to overcome above problems.

In one aspect of the present invention, the binding agent composition for keypad and comprises a UV-curable ink and a surfactant and optionally silicone oil, ethyl alcohol, or hexane.

In another aspect of the present invention, the method for binding keypad on membrane uses UV exposure to cure and bind the keypad and membrane applied with the inventive binding agent composition.

In still another aspect of the present invention, the method for binding keypad on membrane uses UV exposure with flexible time, wavelength and energy.

The various objects and advantages of the present invention will be more readily understood from the following detailed description when read in conjunction with the appended drawing, in which:

### BRIEF DESCRIPTION OF DRAWING

FIG. 1 is a flowchart of the invention;

FIG. 2 is another flowchart of the invention;

FIG. 3 is the sectional view of the invention;

FIG. 4 is the perspective view of the invention.

### DETAILED DESCRIPTION OF THE PREFERRED EMBODIMENT

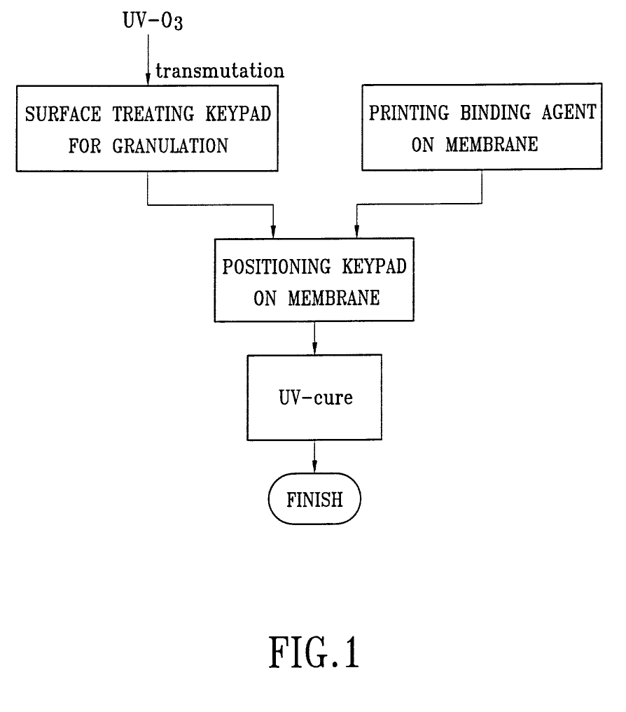

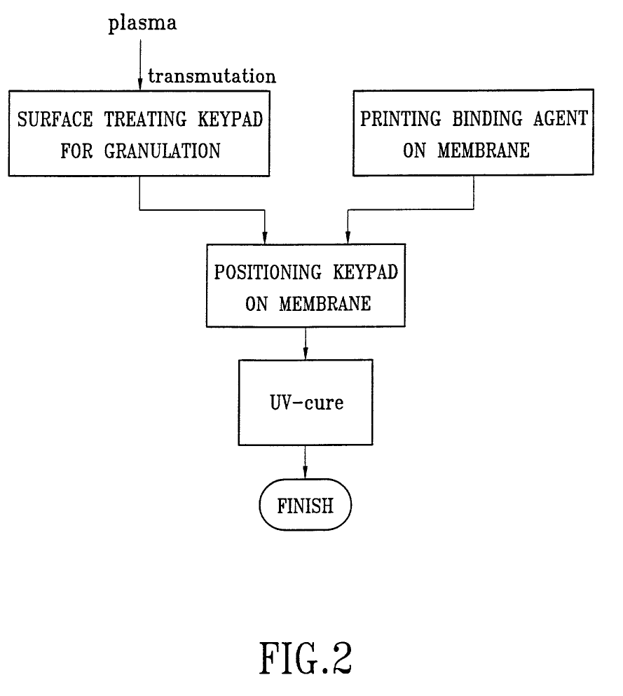

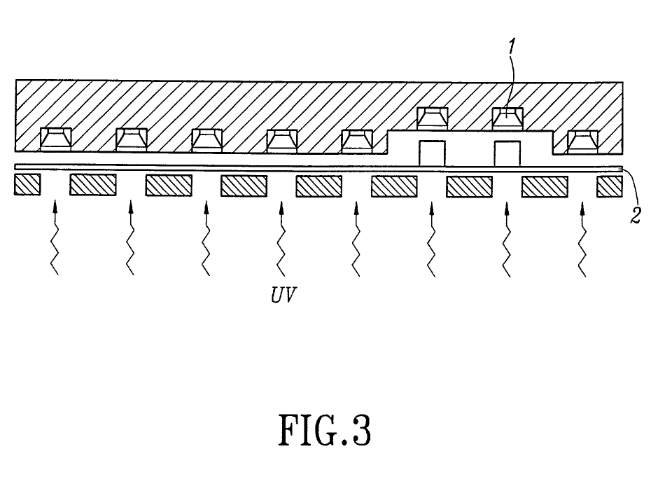

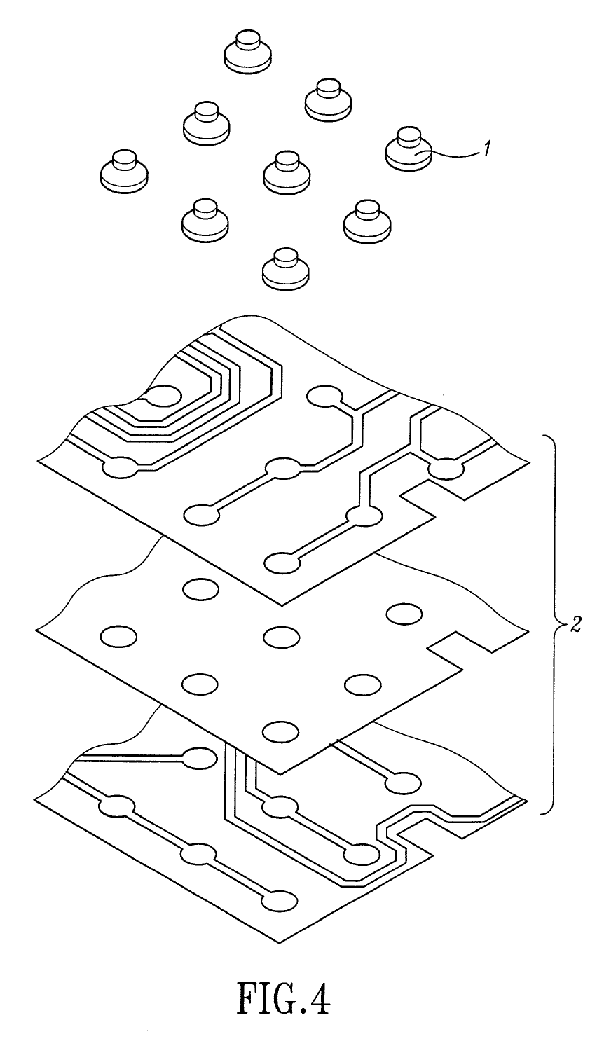

With reference now to FIGS. 1 to 4, the present invention is intended to provide a binding agent composition for keypad and method for binding keypad on membrane, wherein the keypad 1 after granulation treatment and the membrane 2 applied with the inventive binding agent composition can be bound after UV curing. The method for binding keypad on membrane according to the present invention comprises following steps:.

(1) Surface treating the keypad 1 by UV-O₃ or plasma such that the keypad has granulated surface. The treatment time for UV-O₃ is 2.5-4 minutes. The plasma treatment uses He and O₃ reaction in a chamber for 20-30 minutes, preferably 22-28 minutes.

(2) Preparing the inventive binding agent composition with sufficient stirring and mesh-printing the binding agent composition on the membrane. The binding agent composition comprises UV-curable ink and surfactant (Si-H cation type), and optionally solvent. The composition is stirred more than 3 minutes and then meshed printed on the membrane. For examples, the surfactant is 0.5-1 g PAT-121 produced by OTSOTO ALEAG. The UV-curable ink is 28-35 g mixture of urethane and acrylic resin. The solvent is 1-4 g silicone oil, 4-6 g ethyl alcohol, or 1-2 g hexane.

(3) Placing and positioning the keypad on the membrane.

(4) UV-curing the keypad and the membrane such that the membrane is bound to bottom of the keypad. For example, the distance between the UV light source and the keypad is 20-30 cm with 80 W/cm² intensity, 5.7-7 m/min running speed, 10-15 second exposure time and 330-390 nm wavelength. Therefore, the keypad is cured and bound to the membrane.

The binding agent composition for keypad according to the present invention comprises a UV-curable ink and a surfactant with 28:1 to 70:1 weight ratio. For example, the UV-curable ink is 28-35 g mixture of urethane and acrylic resin. The surfactant (Si-H cation type) is 0.5-1 g PAT-121 produced by OTSOTO ALEAG. Moreover, the binding agent composition can be optionally added with solvent such as 1-4 g silicone oil, 4-6 g ethyl alcohol, or 1-2 g hexane.

Preferred Embodiment 1

The keypad can be bound on the membrane with the inventive binding agent composition by following steps:

1. Surface treating the keypad 1 by UV-O₃ such that the keypad has granulated surface. The treatment time for UV-O₃ is 3 minutes.

2. Preparing the inventive binding agent composition with sufficient stirring (more than 3 minutes) and mesh-printing the binding agent composition on the membrane. The binding agent composition comprises

| | | |
|---|---|---|
| (A) UV-curable ink | 30 | g |
| (B) surfactant | 0.8 | g |

3. Placing and positioning the keypad on the membrane.

4. UV-curing the keypad and the membrane such that the membrane is bound to bottom of the keypad. For example, the distance between the UV light source and the keypad is 25 cm with 80 W/cm² intensity, 6 m/min running speed, 10 second exposure time and 360 nm wavelength. Therefore, the keypad is cured and bound to the membrane.

Preferred Embodiment 2

The keypad can be bound on the membrane with the inventive binding agent composition by following steps:

1. Surface treating the keypad 1 by UV-O₃ such that the keypad has granulated surface. The treatment time for UV-O₃ is 3 minutes.

2. Preparing the inventive binding agent composition with sufficient stirring (more than 3 minutes) and mesh-printing the binding agent composition on the membrane. The binding agent composition comprises

| | | |
|---|---|---|
| (A) Silicone oil | 2 | g |
| (B) ethyl alcohol | 5 | g |
| (C) UV-curable ink | 30 | g |
| (D) hexane | 1 | g |
| (E) surfactant | 0.8 | g |

3. Placing and positioning the keypad on the membrane.

4. UV-curing the keypad and the membrane such that the membrane is bound to bottom of the keypad. For example, the distance between the UV light source and the keypad is 25 cm with 80 W/cm² intensity, 6 m/min running speed, 10 second exposure time and 365 nm wavelength. Therefore, the keypad is cured and bound to the membrane.

Preferred Embodiment 3

The keypad can be bound on the membrane with the inventive binding agent composition by following steps:

1. Surface treating the keypad 1 by UV-O₃ such that the keypad has granulated surface. The treatment time for UV-O₃ is 3 minutes.

2. Preparing the inventive binding agent composition with sufficient stirring (more than 3 minutes) and mesh-printing the binding agent composition on the membrane. The binding agent composition comprises

| | | |
|---|---|---|
| (A) Silicone oil | 3 | g |
| (B) ethyl alcohol | 6 | g |
| (C) UV-curable ink | 28 | g |
| (D) hexane | 1.5 | g |
| (E) surfactant | 0.6 | g |

3. Placing and positioning the keypad on the membrane.

4. UV-curing the keypad and the membrane such that the membrane is bound to bottom of the keypad. For example, the distance between the UV light source and the keypad is 22 cm with 80 W/cm² intensity, 6 m/min running speed, 12 second exposure time and 360 nm wavelength. Therefore, the keypad is cured and bound to the membrane.

Preferred Embodiment 4

The keypad can be bound on the membrane with the inventive binding agent composition by following steps:

1. Surface treating the keypad 1 by plasma such that the keypad has granulated surface. The treatment time for plasma is 25 minutes.

2. Preparing the inventive binding agent composition with sufficient stirring (more than 3 minutes) and mesh-printing the binding agent composition on the membrane. The binding agent composition comprises

| | | |
|---|---|---|
| (A) Silicone oil | 3 | g |
| (B) ethyl alcohol | 4 | g |
| (C) UV-curable ink | 28 | g |
| (D) hexane | 1 | g |
| (E) surfactant | 0.5 | g |

3. Placing and positioning the keypad on the membrane.

4. UV-curing the keypad and the membrane such that the membrane is bound to bottom of the keypad. For example, the distance between the UV light source and the keypad is 30 cm with 80 W/cm² intensity, 7 m/min running speed, 14 second exposure time and 340 nm wavelength. Therefore, the keypad is cured and bound to the membrane.

To sum up, the present invention has following advantages:

(1) The binding agent can be composed of different ingredients.

(2) The keypad can be cured and bound to the membrane by UV exposure with different exposure time, wavelength, energy.

(3) The keypad can be firmly bound to the membrane applied with the inventive binding agent composition.

Moreover, the method of the present invention can be summarized to following steps:

(1) Surface treating the keypad such that the keypad has granulated surface.

(2) Preparing the inventive binding agent composition as disclosed in claim 1 and printing the binding agent composition on the membrane.

(3) Placing and positioning the keypad on the membrane treated in step (2).

(4) UV-curing the keypad and the membrane such that the membrane is bound to bottom of the keypad arranged in step (3).

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A binding agent composition for keypad comprises a UV-curable ink and a surfactant with 28:1 to 70:1 weight ratio.

2. The binding agent composition for keypad as in claim 1, wherein said UV-curable ink includes urethane and acrylic resin.

3. The binding agent composition for keypad as in claim 1, wherein said surfactant is Si-H cation type surfactant.

4. A binding agent composition for keypad comprises a UV-curable ink and a surfactant with 28:1 to 70:1 weight ratio, and solvent.

5. The binding agent composition for keypad as in claim 4, wherein said UV-curable ink includes urethane and acrylic resin.

6. The binding agent composition for keypad as in claim 4, wherein said surfactant is Si-H cation type surfactant.

7. The binding agent composition for keypad as in claim 4, wherein said solvent includes silicone oil, ethyl alcohol, or hexane.

8. A method for binding keypad and membrane comprising following steps:
(1) surface treating the keypad such that the keypad has granulated surface;
(2) preparing the binding agent composition as disclosed in claim 1 and printing the binding agent composition on said membrane;
(3) placing and positioning said keypad on said membrane treated in step (2).
(4) UV-curing said keypad and said membrane such that said membrane is bound to bottom of said keypad arranged in step (3).

9. The method for binding keypad and membrane as in claim 8, wherein said surface treating in step (1) uses UV-O3 treatment.

10. The method for binding keypad and membrane as in claim 9, wherein time for said UV-O3 treatment is 2.5-4 minutes.

11. The method for binding keypad and membrane as in claim 8, wherein said surface treating in step (1) uses plasma treatment.

12. The method for binding keypad and membrane as in claim 11, wherein said plasma treatment uses He and O₂ reaction in a chamber for 20-30 minutes.

13. The method for binding keypad and membrane as in claim 8, wherein said UV-curing has the following parameters: distance between the UV light source and the keypad 20-30 cm, 10-15 second exposure time.
